(19) United States
(12) Patent Application Publication
(10) Pub. No.: US 2020/0018662 A1
(43) Pub. Date: Jan. 16, 2020

(54) PIPELINE LEAK DETECTION

(71) Applicants: King Fahd University of Petroleum and Minerals, Dhahran (SA); Pipeline Technologies & Services LLC (DBA PIPETECH), Al-Khobar (SA)

(72) Inventors: Muhammad A. HAWWA, Dhahran (SA); Hussain M. AL-QAHTANI, Dhahran (SA); Mowaffak T. MIDANI, Al-Khobar (SA); Mukassir AHMED, Al-Khobar (SA); Yousef Ali SENAN, Al-Khobar (SA)

(73) Assignees: King Fahd University of Petroleum and Minerals, Dhahran (SA); Pipeline Technologies & Services LLC (DBA PIPETECH), Al-Khobar (SA)

(21) Appl. No.: 16/032,662

(22) Filed: Jul. 11, 2018

(51) Int. Cl. G01M 3/14; F16L 55/00; G01L 1/22; G01M 3/36

(52) U.S. Cl. CPC G01M 3/143; F16L 55/00; F16L 2201/30; G01M 3/36; G01L 1/2262

(57) ABSTRACT

To detect a leak in a pipe carrying a fluid, an elastic membrane circumferentially surrounds the pipe. A sensing device detects an expansion state of the membrane and a signaling device indicates the presence of the leak based on the expansion state of the membrane.

### BACKGROUND

### Technical Field

The present disclosure is related to leak detection in pipelines.

### Description of the Related Art

Pipelines are a primary means for transporting fluids (water, oil, gas, chemical products, etc.); over two million miles of pipeline currently exist globally. Pipelines are typically constructed by connecting several pipe segments together. FIG. 1 is an illustration of a pair of pipe segments 110a and 110b connected at their ends 112a and 112b to form a joint 115. Joint 115 may be formed in a variety of ways, such as by welding (butt welding, socket welding, etc.), brazing and soldering, threading or screwing, grooving, flanging, compression fitting, and so on. Regardless of the segment connection method, all pipe joints are considered to be vulnerable domains, i.e., susceptible to leakage. Other vulnerable domains in which leaks may form are excessive pressure, corrosion, thinning of pipe walls, among many others.

While pipelines are generally inspected routinely, a leak can occur in a pipeline at any time and constant vigil over every vulnerable domain in a pipeline by human monitors is prohibitive. The search for practical pipeline leak monitoring techniques is ongoing.

### SUMMARY

To detect a leak in a pipe carrying a fluid, an elastic membrane circumferentially surrounds the pipe. A sensing device detects an expansion state of the membrane and a signaling device indicates the presence of the leak based on the expansion state of the membrane.

In one aspect of the invention, the sensing device may be a strain gauge.

In another aspect of the invention, an electric circuit may be electrically coupled to the strain gauge to provide a signal to the signaling device based on the expansion state of the membrane.

In another aspect of the invention, the electric circuit may be a bridge circuit.

In yet another aspect of the invention, the signaling device includes a wireless transmitting circuit to send an indication of the expansion state of the membrane to a remote receiver circuit.

In another aspect of the invention, a set of retaining rings may retain the membrane at ends thereof against the pipe.

In another aspect of the invention, the retaining rings may be O-rings.

### BRIEF DESCRIPTION OF THE DRAWINGS

FIG. 1 is a diagram of a typical pipeline joint.

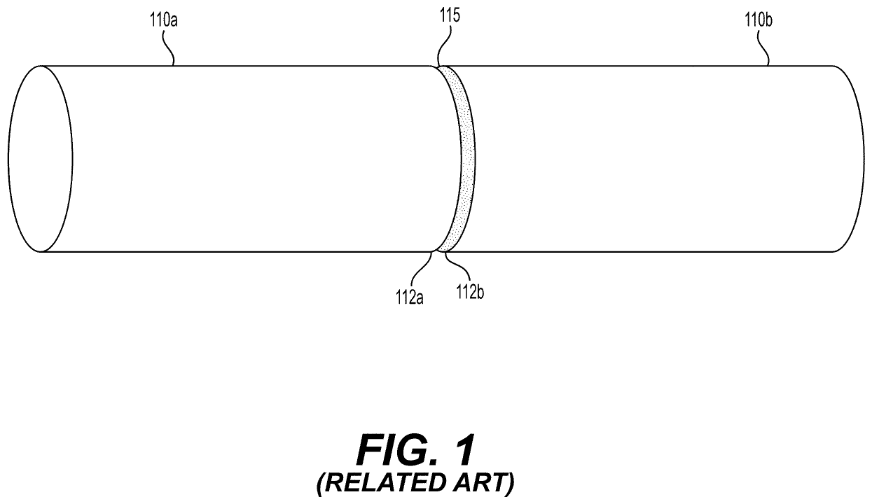

FIG. 2 is an illustration of an example pipeline in which the present inventive concept can be embodied.

FIG. 3 is a diagram illustrating an example pipeline assembly process by which the present inventive concept may be embodied.

FIG. 4A is a detailed view of a pipeline assembled per the pipeline assembly process of FIG. 3.

FIG. 4B is an illustration of an elastic membrane in an expanded state.

FIG. 5 is a diagram illustrating the example pipeline illustrated in FIG. 4 having leak detection circuitry assembled thereon by which the present inventive concept can be embodied.

FIG. 6 is a schematic diagram of example leak detection circuitry with which the present inventive concept can be embodied.

FIG. 7 is a schematic diagram of an example pipeline system in which the present inventive concept can be embodied.

FIG. 8 is a flow diagram illustrating an example leak detection process by which the present inventive concept can be embodied.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

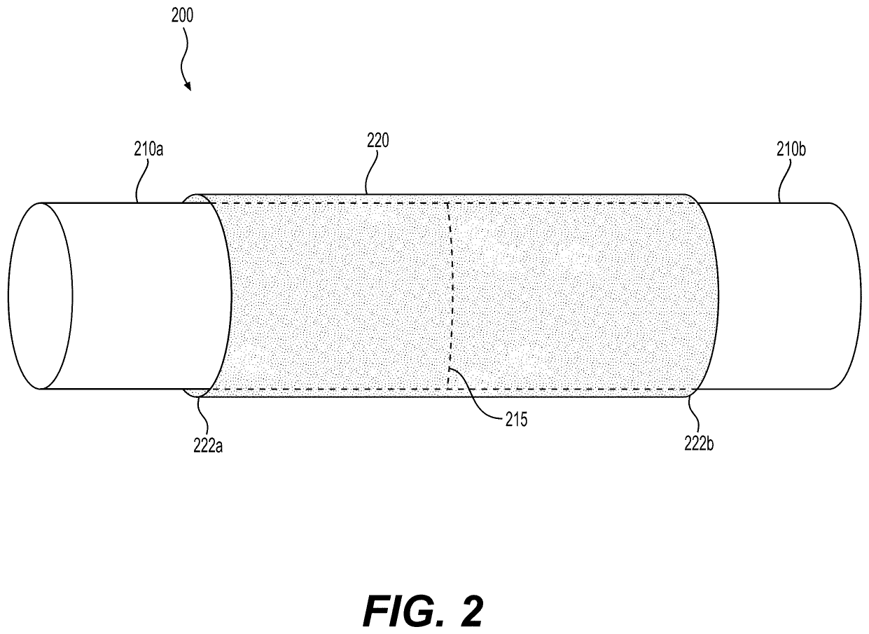

FIG. 2 is an illustration of an example pipeline 200 in which the present invention can be embodied. Pipeline 200 includes a pipe joint 215 between a pair of pipe segments 210a and 210b, representatively referred to herein as pipe segment(s) 210. The present invention is not limited to a particular technique by which pipe segments 210 are connected; numerous pipe connecting techniques and mechanisms, such as those described above, may be used in conjunction with embodiments of the invention without departing from the spirit and intended scope thereof. Pipe joint 215 is considered a vulnerable domain in pipeline 200.

As illustrated in FIG. 2, pipeline 200 may include an elastic membrane 220 extending longitudinally along pipeline 200 to encompass a vulnerable domain, such as pipe joint 215. Elastic membrane 220 may be circumferentially continuous, i.e., without a break or opening other than at ends 222a and 222b of elastic membrane 220. For example, elastic membrane 220 may be in the form of a tube made from an elastic material such as natural or synthetic rubber. The material used to construct elastic membrane 220 may be chosen to be chemically compatible to the substance being transported so as to avoid degradation of elastic membrane 220 should a leak occur.

In one embodiment of the invention, membrane 220 is made of an elastomeric thermoplastic polymer. The elastic thermoplastic polymer, in one embodiment of the invention, is the single material from which membrane 220 is made. Membrane 220 is preferably of homogeneous construction such that the thickness of the membrane does not vary around the circumference of the membrane or along its axial length. In a preferable embodiment of the invention, membrane 220 is made from an elastomeric thermoplastic polymer composition that contains one or more organic or inorganic fillers. Fillers are preferably carbon-based nanomaterials such as carbon nano-tubes. Alternately, micro fibers of thermoset polymers such as polyesters or carbonized polymers may be homogenously dispersed throughout the composition and throughout the circumference and length of the membrane. In other embodiments the filler material may be a carbonized material that consists of or comprises graphene and/or carbon nanotube particles that are aligned, preferably unidirectionally, around the circumference or length of the membrane.

Other fillers may be inorganic particles and/or nanoparticles. For example, metallic nanoparticles may be dispersed homogeneously throughout the elastomeric thermoplastic polymer composition. Strain may be measured according to resistance circumferentially or lengthwise along the membrane. Metallic particles may include, for example, conductive materials such as silver, copper and iron although any conductive and preferably non-oxidating transition metals may be used. In other embodiments one or more semiconductor materials or nanoparticles of a main group element are present in the elastomeric thermoplastic polymer composition.

In a preferred embodiment of the invention the membrane is a multi-layer membrane comprising at least two layers of elastomeric thermoplastic polymer materials in direct contact with one another. The layers of elastomeric thermoplastic polymer compositions are of different composition with an inner layer directly adjacent to or most closely associated with surface of the pipeline containing no further material and an outside layer containing one or more of the filler materials described herein. In a further preferred embodiment of the invention the membrane is includes one or more layers that contain a series of repetitive circumferentially oriented stripes of different composition. For example, a first stripe may be made from an elastomeric thermoplastic polymer composition that does not contain a filler whereas a second stripe is made of the same elastomeric thermoplastic polymer but is a composition that further includes one or more of the fillers described herein. The stripes represent a repeating pattern. Each stripe may have a length, measured along the pipe axis, of 1/50- 1/10 of the length of the membrane. The presence of stripes circumferentially oriented along the membrane appears to focus strain along joins of stripes thereby enhancing the sensitivity of the membrane for detecting and measuring leaks.

Elastomeric thermoplastic polymers include, for example, styrenic block copolymers, thermoplastic polyolefinelastomers, thermoplastic Vulcanizates, thermoplastic polyurethanes, thermoplastic copolyester, and thermoplastic polyamides.

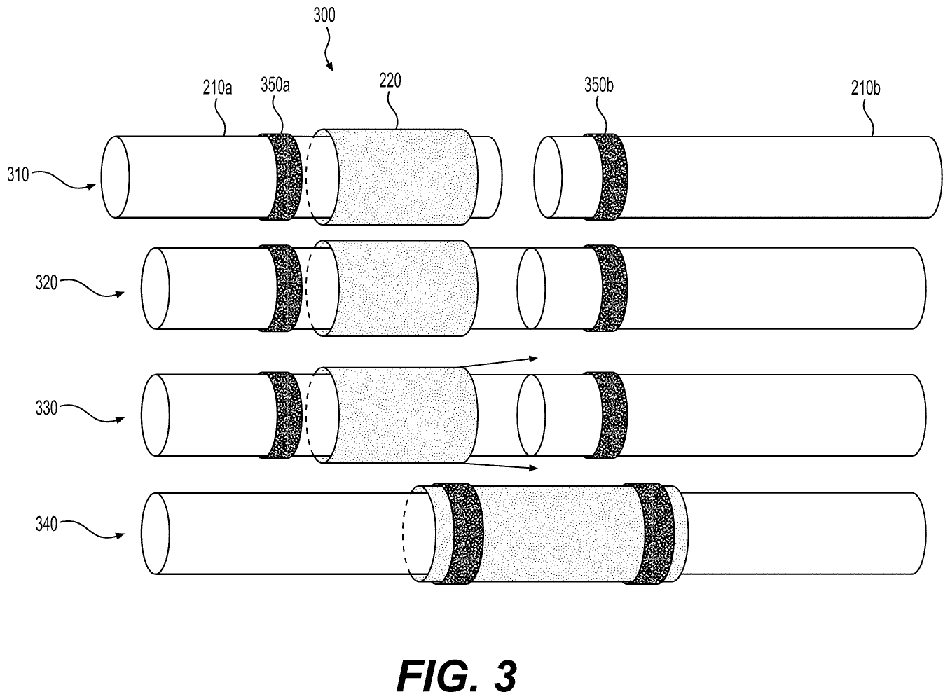

FIG. 3 is a diagram illustrating an example pipeline assembly process 300 by which the present invention may be embodied. In operation 310, a pair of retaining rings 350a and 350b, representatively referred to herein as retaining ring(s) 350, are placed on each pipe segment 210 prior to connecting pipe segments 210 together. Also, elastic membrane 220 is placed on one pipe segment 210 prior to connecting pipe segments 210 together. In operation 320, pipe segments 210 are joined together such as by welding, brazing, soldering, threading, grooving, flanging, compression fitting, etc. In operation 330, elastic membrane 220 is moved to encompass or otherwise span the vulnerable domain of the connection created in operation 320. In operation 340, elastic membrane 220 is secured to pipeline 200 by retaining rings 350. In certain embodiments, retaining rings 350 are elastic O-rings, although the present invention is not so limited. That is, other types of retaining rings, e.g., pipe clamps, zip ties, etc., may be used in conjunction with embodiments of the invention.

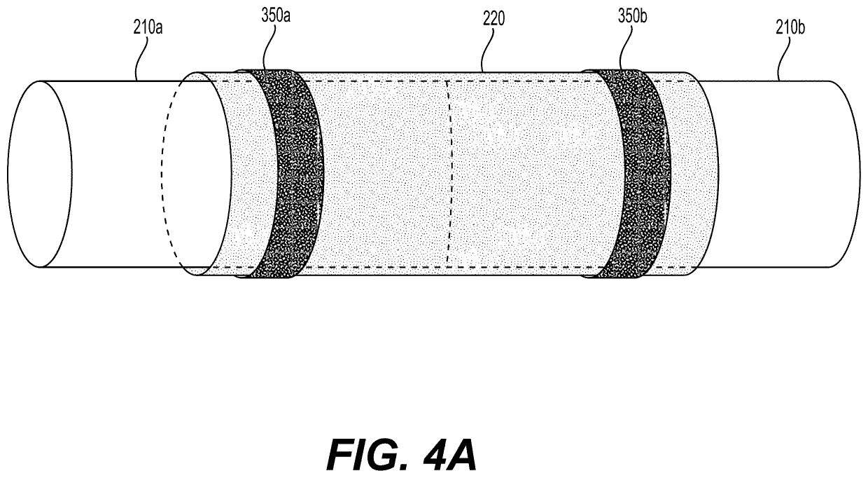

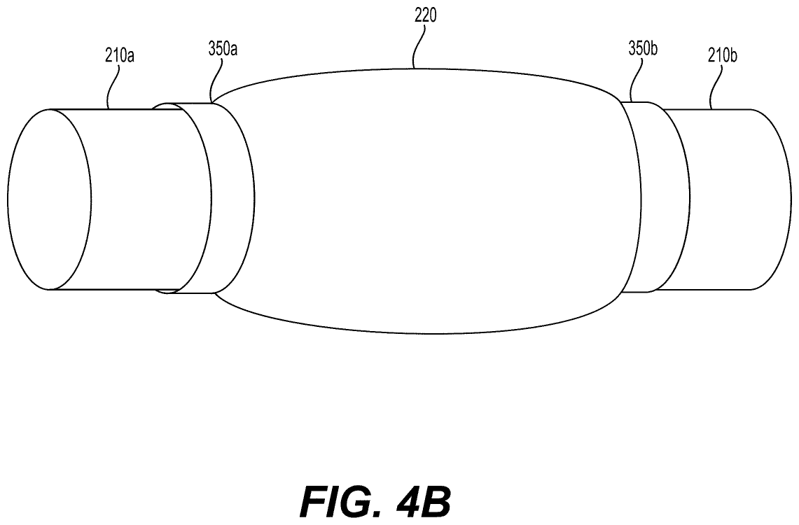

FIG. 4A is a detailed view of pipeline 200 assembled per pipeline assembly process 300 and FIG. 4B illustrates an example where a leak has occurred and elastic membrane 220 is in an expanded state. It is to be understood that while elastic membrane 220 is illustrated in a symmetrical expansion state, such may not always be the case. Indeed, elastic membrane may expand asymmetrically, such as when fluid collects and settles on one side of membrane 220 under the influence of gravity.

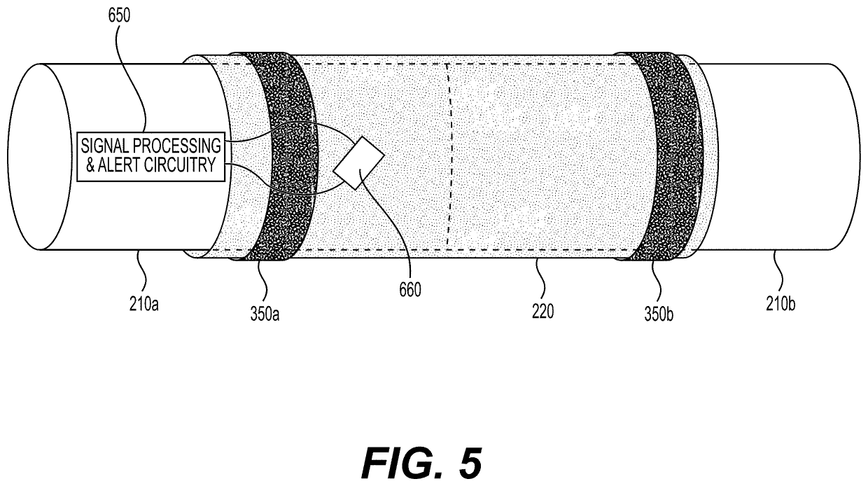

FIG. 5 is a diagram illustrating example pipeline 200 illustrated in FIG. 4 having leak detection circuitry 600 assembled thereon. Should a leak occur in a region of pipeline 200 that is encompassed by elastic membrane 220 and between retaining rings 350, elastic membrane 220 will inflate or otherwise expand to contain the leaking fluid, as described above. Leak detection circuitry 600 may be constructed or otherwise configured to detect and indicate when such expansion occurs and may indicate the amount of expansion that elastic membrane 220 is undergoing. To that end, detection circuitry 600 may include signal processing and alert circuitry 650 electrically coupled to a sensor 660. Signal processing and alert circuitry 650 may alert personnel of the leak condition based on the expansion state of elastic membrane 220 indicated to by sensor 660, while the leak itself may be contained within elastic membrane 220 and retaining rings 350. The present invention is not limited to particular signaling or alert mechanisms; upon review of this disclosure, those having skill in the art will recognize numerous signaling and alerting techniques that can be used in conjunction with embodiments of the present invention.

Strain may be measured by one or more PV electric resistance meters that measure resistance through the membrane in one or more of a circumferential or longitudinal direction. Changes in the resistance of membrane 220 can be constantly monitored and compared with a reference membrane that is installed on a section of pipe without covering a pipe joint. Comparison in the resistance or change in resistance between a first membrane covering a pipe joint and a second membrane reference membrane covering a virgin or unjoined section of pipe permits detection of strain through a comparison of the resistance of the respective membranes and/or a comparison of the change of resistance of the comparative membranes. Using a comparative membrane permits isolation and elimination of noise and changes in resistance due to environmental conditions unrelated to the quality of the pipe join or the presence of a leak in the pipeline.

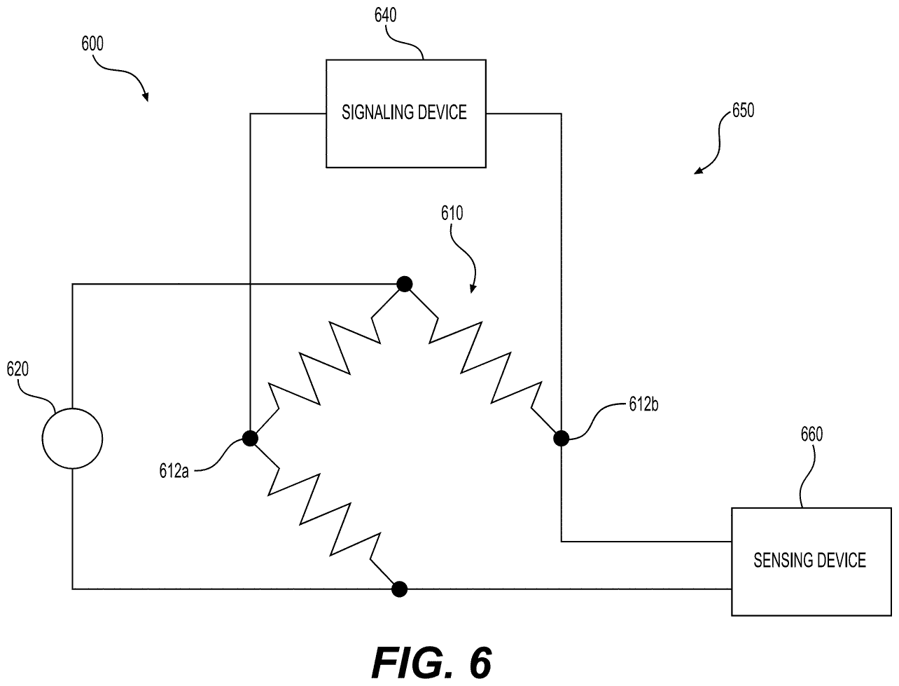

FIG. 6 is a schematic diagram of example leak detection circuitry 600 with which the present invention can be embodied. As illustrated in the figure, leak detection circuitry 600 may comprise a Wheatstone bridge 610 connected to a suitable power supply 620. As illustrated in the figure, one of the resistor legs of Wheatstone bridge 610 is occupied by a sensing device 660. In one embodiment, sensing device 660 is a strain gauge that has a resistance across its terminals that depends on the amount of strain asserted thereon. Such a strain gauge may be affixed to elastic membrane 220, such as by an adhesive, so that expansion thereof applies force across the strain gauge thereby compelling a change in resistance. The change in resistance causes a voltage change at output terminals 612a and 612b, which is applied to signaling device 640. It is to be understood that circuits other than Wheatstone bridge 610 may be deployed to process the signal from sensing device 660, as will be appreciated by those skilled in the electrical/electronic arts.

Signaling device 640 may be implemented in a wide range of devices by which personnel are alerted to the expansion state of elastic membrane 220. Signaling device 640 may be a simple annunciator, such as a buzzer, klaxon or flashing light, or may contain processing and communication circuitry through which remote personnel are alerted to the leak condition. For example, in one embodiment described in more detail below, signaling device 640 may comprise a wireless transmitter that conveys an indication of the expansion state of elastic membrane 220 to a remote wireless receiver. An indicator as to the expansion state of elastic membrane 220 may be located at the remote wireless receiver.

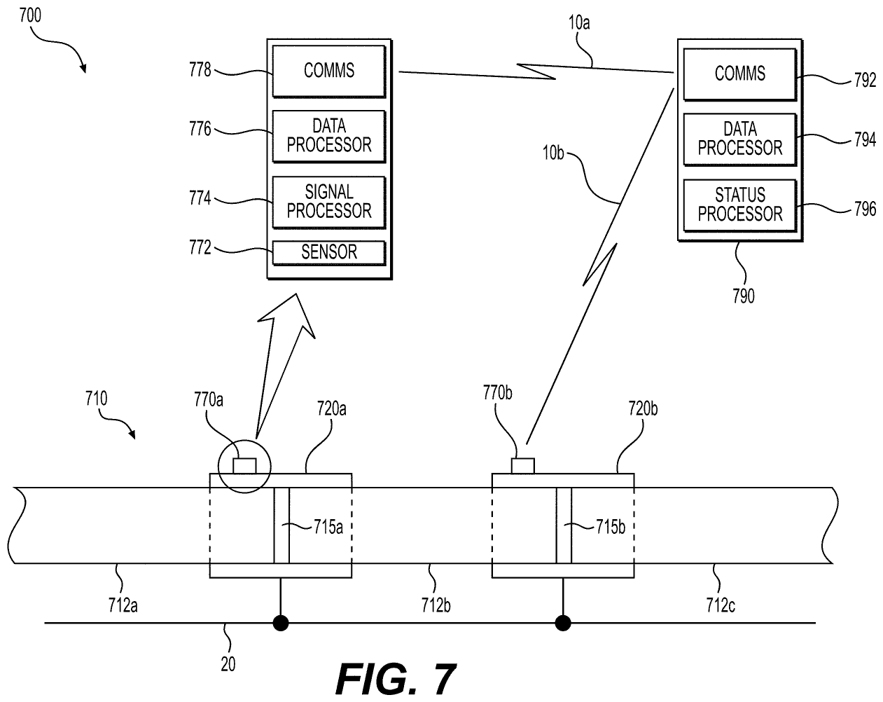

FIG. 7 is a schematic diagram of an example pipeline system 700 in which the present invention can be embodied. As is illustrated in the figure, pipeline system 700 includes a pipeline 710 comprising multiple pipe segments 712a-712c, representatively referred to herein as pipe segment(s) 712, mechanically interconnected one with another at joints 715a-715b, representatively referred to herein as joint(s) 715. In FIG. 7, pipeline 710 is depicted in cross-section to illustrate the location of joints 715. Additionally, whereas only two joints 715 are illustrated in FIG. 7, pipeline 710 may comprise numerous such joints.

Elastic membranes 720a and 720b, representatively referred to herein as elastic membrane(s) 720, may be mechanically fixed to adjacent pipe segments 712 so as to encompass or otherwise extend across joints 715. The elastic membranes 720 may be fixed to pipe segments 712 by a suitable fastening mechanism, such as by those mechanisms described above. A depiction of such fastening mechanism has been omitted from FIG. 7 so as to prevent unnecessarily congesting the figure.

A leak detection device 770a and 770b, representatively referred to herein leak detection device(s) 770, may be affixed to each membrane 720. As is illustrated in the figure, each instance of leak detection device 770 may include sensor circuitry 772, signal processor circuitry 774, data processor circuitry 776 and communications circuitry 778. In one example, sensor circuitry 772 may include the strain gauge/Wheatstone bridge circuit described above. Signal processor circuitry 774 may filter or otherwise condition the sensor signal from sensor circuitry 772 and may convert an analog signal, should that be the output of sensor circuitry 772, into a digital representation of the sensor signal. Data processor circuitry 776 may operate on the digital data and may perform functions on and/or derive information from those data, e.g., conversion into particular units of measure, ascertaining statistical properties (mean, max, min, etc.), comparing the sensor signal to one or more thresholds or indexes, etc. Data from data processor circuitry 776 may be provided to communications circuitry 778, where the data may be transformed or otherwise formatted to be conveyed over a medium, such as air or transmission lines.

For example, a strain gauge may be affixed to the elastic membrane by an adhesive and remaining leak detection circuitry may be affixed to a nearby portion of a pipe segment, on a nearby pole and even on the elastic membrane itself.

Leak detection devices 770 may obtain operating power via from a central power source, such as through a distribution conductor 20. Alternatively, each leak detection device may include an onboard power source, such as a battery and/or solar panels. The present invention is not limited to particular power provisioning techniques; those having skill in the art will recognize numerous such techniques that can be used in conjunction with the present invention without departing from the spirit and intended scope thereof.

Pipeline system 700 may include a receiver station 790 communicatively coupled to leak detection devices 770a and 770b through respective communication links 10a and 10b, representatively referred to herein as communication link(s) 10. Receiver station 790 may be a facility at which monitoring tasks of pipeline 710 are assigned and need not be collocated with leak detection circuitry 770. Indeed, communication links 10 may be capable of conveying data over great distances, such as over satellite links or suitable communications technology, such as 5G. Pipeline system 700 may constructed or otherwise configured to participate in an Internet of Things paradigm.

Receiver station 790 may include receiver circuitry including communications circuitry 792 at which communication links 10 from respective leak detection devices 770 terminate, data processor circuitry 794 to process the data conveyed from each leak detection device 770 and status processor circuitry 796 to indicate the expansion states (or derivative leak information) of membranes 720 to human personnel, such as by visual display, audible alarm, etc.

Whereas only a single receiver station 790 is illustrated in FIG. 7, the present invention is not so limited. Embodiments of the invention may have multiple receiver stations 790 distributed in space, such as along pipeline 710.

Signal processor circuitry 774 may include components and sub-circuits by which a sensor signal is conditioned for further processing including where such processing is by digital means. For example, signal processor circuitry may include amplifier circuits, filter circuits, analog-to-digital conversion circuits, and other circuits known to technicians skilled in the signal processing arts.

Leak detection devices 770 and receiver station 790 are communicatively connected to each other, for example, via a network through communication circuits 778 and 792, which represent any hardware and/or software configured to communicate information via any suitable communications media (e.g., air, transmission line, etc.), and may include routers, hubs, switches, gateways, or any other suitable components in any suitable form or arrangement. The various components of the system may include any conventional or other communications devices to communicate over the networks via any conventional or other protocols, and may utilize any type of connection (e.g., WAN, LAN, Internet, Intranet, wired, wireless, etc.) for access to the network.

Data processor circuits 776 and 794 are, for example, one or more data processing devices such as microprocessors, microcontrollers, systems on a chip (SOCs), or other fixed or programmable logic, that executes instructions for process logic stored the memory. The processors may themselves be multi-processors, and have multiple CPUs, multiple cores, multiple dies comprising multiple processors, etc.

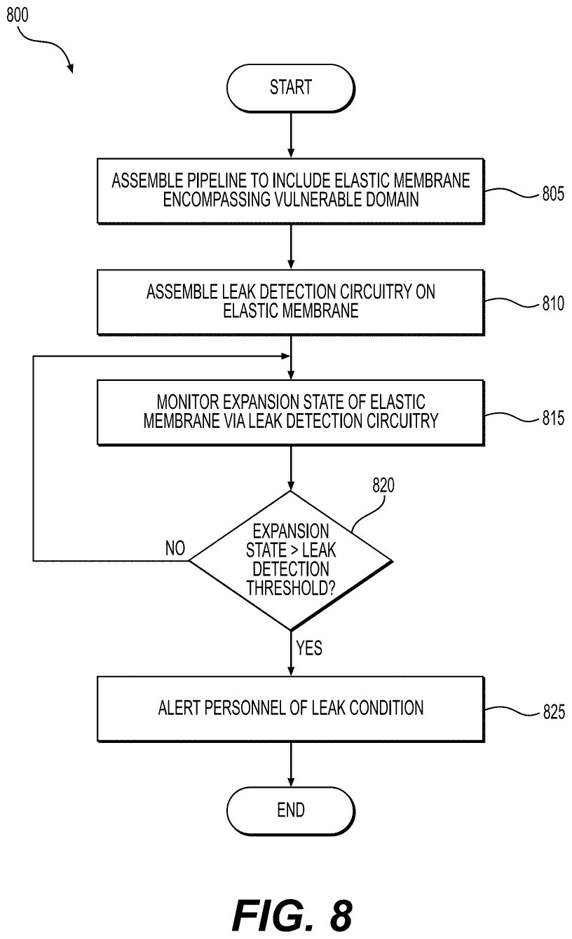

FIG. 8 is a flow diagram illustrating an example leak detection process 800 by which the present invention can be embodied. In operation 805, a pipeline is assembled to include one or more elastic membranes respectively encompassing one or more vulnerable domains, such as pipe joints. Such assembly may occur according to the operations described above with reference to FIG. 3. In operation 810 of process 800, leak detection circuitry may be assembled on the elastic membrane such that the sensing circuitry is affixed thereon. In operation 815, the expansion state of the elastic membrane is monitored via the leak detection circuitry and in operation 820, it is determined whether a leak condition exists, such as by evaluating the expansion state of the elastic membrane against a leak detection threshold criterion. If the expansion state is greater than the leak detection threshold, process 800 may transition to operation 825, by which personnel are alerted to the leak condition. If the expansion state is not greater than the leak detection threshold, as determined in operation 820, process 800 may transition to operation 815 where monitoring activities are continued.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

1. An apparatus for detecting a leak in a pipe carrying a fluid comprising:
an elastic membrane to circumferentially surround the pipe;
a sensing device to detect an expansion state of the membrane; and
a signaling device to indicate the presence of the leak based on the expansion state of the membrane.

2. The apparatus of claim 1, wherein the sensing device is a strain gauge.

3. The apparatus of claim 2, further comprising:
an electric circuit electrically coupled to the strain gauge to provide a signal to the signaling device based on the expansion state of the membrane.

4. The apparatus of claim 3, wherein the electric circuit is a bridge circuit.

5. The apparatus of claim 1, wherein the signaling device includes a wireless transmitting circuit to send an indication of the expansion state of the membrane to a remote receiver circuit.

6. The apparatus of claim 1, further comprising:
a set of retaining rings to retain the membrane at ends thereof against the pipe.

7. The apparatus of claim 6, wherein the retaining rings are O-rings.

8. A pipeline comprising:
pipe segments interconnected one with another at joints;
elastic membranes to circumferentially surround the pipe segments across the respective joints;
sensing devices to detect expansion states of the respective membranes; and
signaling devices to indicate the presence of leaks at the respective joints based on the expansion states of the membranes.

9. The pipeline of claim 8, wherein the sensing devices are strain gauges.

10. The pipeline of claim 9, further comprising:
electric circuits electrically coupled to the respective strain gauges to provide a signal to the signaling devices based on the expansion state of the membranes.

11. The apparatus of claim 10, wherein the electric circuits are bridge circuits.

12. The pipeline of claim 8, wherein the signaling devices include respective wireless transmitting circuits to send an indication of the expansion state of the corresponding membranes to a remote receiver circuit.

13. The apparatus of claim 8, further comprising:
retaining rings to retain the respective membranes at ends thereof against the pipe.

14. The pipeline of claim 13, wherein the retaining rings are O-rings.

15. A method of detecting a leak in a pipe carrying a fluid comprising:
interconnecting pipe segments one with another at a joint to include an elastic membrane circumferentially surrounding the pipe segments across the joint;
assembling sensing devices to the elastic membrane to detect an expansion state thereof;
determining whether the expansion state of the elastic membrane meets a leak detection criterion; and
indicating presence of leaks at the joint responsive to the determination that the expansion state of the elastic membrane meets the leak detection criterion.

16. The method of claim 15, wherein the sensing device is strain gauge.

17. The method of claim 16, further comprising:
electrically coupling an electric circuit to the respective strain gauge to provide a signal based on the expansion state of the membranes.

18. The method of claim 17, wherein the electric circuit is a bridge circuit.

19. The method of claim 15, further comprising:
transmitting an indication of the expansion state of the elastic membrane to a remote receiver circuit.

20. The method of claim 7, wherein determining whether the expansion state of the elastic membrane meets a leak detection criterion is performed at the receiving circuitry.
